(19) United States
(12) Patent Application Publication
(10) Pub. No.: US 2018/0046363 A1
(43) Pub. Date: Feb. 15, 2018

(54) Digital Content View Control

(71) Applicant: Adobe Systems Incorporated, San Jose, CA (US)

(72) Inventors: Gavin Stuart Peter Miller, Los Altos, CA (US); Sachin Soni, New Delhi (IN); Anmol Dhawan, Ghaziabad (IN); Ashish Duggal, Delhi (IN)

(73) Assignee: Adobe Systems Incorporated, San Jose, CA (US)

(21) Appl. No.: 15/233,532

(22) Filed: Aug. 10, 2016

(51) Int. Cl. G06F 3/0484; G06F 3/00; G06F 3/0481; G06F 3/01

(52) U.S. Cl. CPC G06F 3/04847; G06F 3/013; G06F 3/017; G06F 3/005; G06F 3/04815; G06F 3/04842

(57) ABSTRACT

Digital content view control techniques are described. In one example, a virtual control is used to supplement navigation of digital content without movement of a user's head through use of an appendage such as a hand, finger, and so forth. In another example, a digital content view control technique is configured to reduce potential nausea when viewing the digital content. Techniques and systems are described that incorporate a threshold to control how the digital content is viewed in relation to an amount of movement to be experienced by the user in viewing the digital content. Based on this amount of movement, a determination is made through comparison to a threshold to control output of transitional viewpoints between the first and second viewpoints.

### BACKGROUND

Users are exposed to an ever increasing range of immersive digital content. Immersive digital content is configured to support a plurality of viewpoints that are not typically viewed together at any one time. Rather, the plurality of viewpoints is made available to the user, typically in response to movement of the user. For example, a user may capture a 360-degree digital image, which is then viewed through movement of a device (e.g., a phone or wearable) or a user's head (e.g., when implemented using goggles or other headwear), to be exposed to the different viewpoints of the image. Other examples include use of virtual experiences in a virtual reality or augmented reality scenario in which objects are disposed in an environment “around” the user. In this way, a user is immersed when viewing the digital content, e.g., as if the user was “actually there.”

However, the immersion supported by this digital content also presents unique challenges. Conventional techniques regarding augmented and virtual reality scenarios, and even 360-degree digital image scenarios, typically require movement on the part of the user that mimics the immersion within the environment to navigate through the content. Users, for instance, that wish to view portions of the digital content that are disposed “behind them” are forced to rotate their head 180 degrees or move their phone behind them to view this portion of the content. This navigation may eventually become tiring and frustrating to the user, especially when creating and modifying the content and thus may run counter to desired uses of immersive digital content.

### SUMMARY

Digital content view control techniques are described. In one example, a virtual control is used to supplement navigation of digital content. A user, for instance, may navigate a display of immersive digital content through detected movements of parts of the user's head, e.g., gaze tracking, the head as a whole, and so forth. A virtual control is also implemented to support navigation as part of an augmented or virtual reality scenario, when viewing a 360-degree digital image, and so on without movement of a user's head through use of an appendage such as a hand, finger, and so forth.

In another example, a digital content view control technique is configured to reduce potential nausea when viewing the digital content. Techniques and systems are described that incorporate a threshold to control how the digital content is viewed in relation to an amount of movement to be experienced by the user in viewing the digital content. Based on this amount of movement, a determination is made through comparison to a threshold to control output of transitional viewpoints between the first and second viewpoints. For lesser amounts of movement that are below the threshold, the transitional viewpoints are output to provide a continuous view of the digital content. For amounts over the threshold, output of at least one of the plurality of transitional viewpoints is not performed to jump between these viewpoints.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 is a flow diagram depicting a procedure in an example implementation in which a virtual control is manipulated by an appendage of a user to control navigation of digital content that is also navigable based on at least partial motion of a user's head or a computing device used to display the content.

FIGS. 3 and 4 depict example implementations of the virtual control of FIG. 2 as mimicking a physical control as part of a user interface that is used to display immersive digital content.

FIG. 5 depicts an example implementation of the virtual control of FIG. 2 as implemented using representations of different viewpoints that are selectable to cause navigation to the represented viewpoints of immersive digital content.

FIG. 6 depicts an example implementation of the virtual control of FIG. 2 as implemented using representations of different viewpoints that are selectable to cause navigation to the represented viewpoints of digital content configured as a three-dimensional model.

FIG. 7 depicts an example implementation of navigation between viewpoints that includes output of a preview.

FIG. 8 is a flow diagram depicting a procedure in an example implementation in which navigation in relation to digital control is controlled through use of a threshold.

FIG. 9 depicts a system in an example implementation in which navigation in relation to digital control is controlled through use of a threshold.

FIG. 10 depicts an example implementation of control of display of the digital content as including transitional viewpoints to support an appearance of continuous movement in relation to digital content.

FIG. 11 depicts an example implementation of control of display of the digital content as not including transitional viewpoints as support an appearance of jumping between different viewpoints in the digital content.

FIG. 12 illustrates an example system including various components of an example device that can be implemented as any type of computing device as described and/or utilize with reference to FIGS. 1-11 to implement embodiments of the techniques described herein.

### DETAILED DESCRIPTION

Overview

Techniques and systems are described to navigate digital content. An example of this is immersive digital content in which a user is provided a plurality of viewpoints, from which, the digital content is viewed as if the user is disposed in an environment defined by the digital content Immersive digital content includes 360-degree digital images, virtual reality environments, augmented relative environments, and others.

Conventional navigation of immersive digital content involves movement of the user, such as to turn the users' head or body as a whole, to view different portions of the content. Thus, each of these different portions are viewable via a respective viewpoint to the digital content. In this way, users feel immersed within the digital content and view the content as displayed “around them.” However, this may also lead to user fatigue, even to the point that the users may choose to forgo additional interaction with this content using conventional techniques, e.g., due to a sore neck. This may also be inappropriate in certain situations, such as to require users to turn around in a desk chair to “view what's behind them.”

Accordingly, digital content view control techniques and systems are described. In one example, a virtual control is used to supplement navigation of digital content, such as the immersive digital content described above. A user, for instance, may navigate a display of immersive digital content through detected movements of parts of the user's head, e.g., gaze tracking, the head as a whole, and so forth.

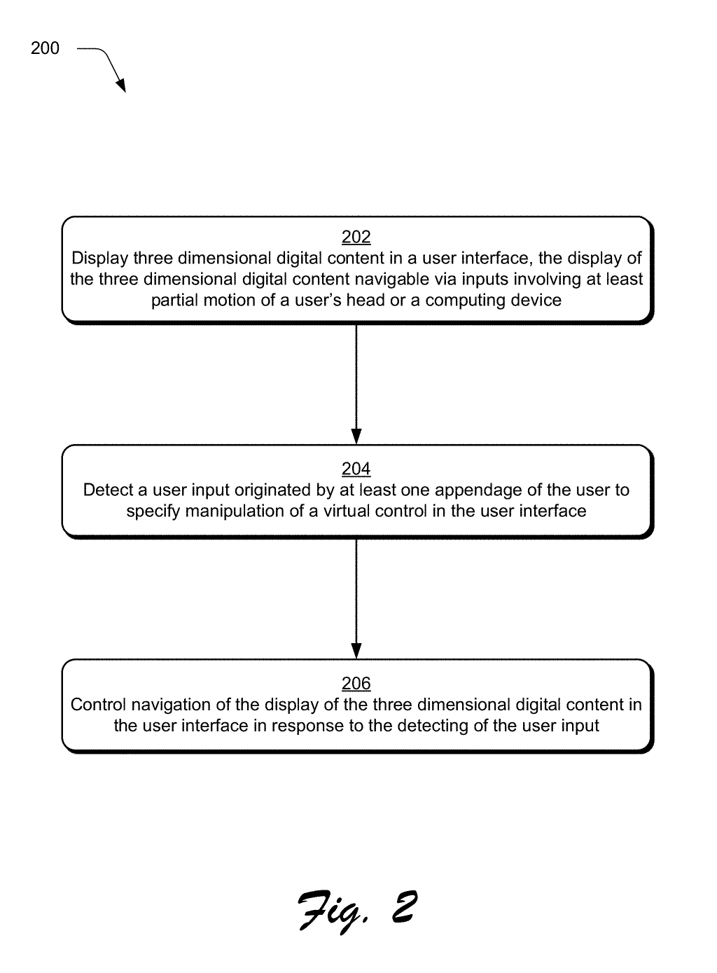

A virtual control is also implemented to support navigation as part of an augmented or virtual reality scenario, when viewing a 360-degree digital image, and so on. User interaction, for instance, may be detected with this virtual control as part of a natural user interface such that the virtual control is “not really there”. This user interaction may be detected in a variety of ways, such as a forward facing camera, radar techniques, or any other technique in which movement of an appendage of the user (e.g., a user's hand, fingers of the user's hand, and so forth) may be detected. Based on this movement of the user's appendage (e g, mimicking the turn of a virtual dial, selection of a thumbnail in a AR/VR scenario, and so forth), the display of the digital content may move accordingly, such as to pan to view “what is behind” the user without forcing a head turn of 180 degrees. In another instance, the virtual control is implemented at least in part using a physical input device, which may also provide haptic feedback. A representation of the physical input device may also be included in a user interface as described above. Other instances are also described in the following in relation to FIGS. 2-7 regarding this example, including use of previews, annotations, and so forth.

In another example, a digital content view control technique is configured to reduce potential nausea when viewing the digital content. In conventional techniques, a user may experience nausea when quickly navigating through different viewpoints of digital content, such as when viewing a three-dimensional model and especially when viewing immersive digital content. Users, for instance, may view a portion of the digital content that is “in front of them” but then wish to view a portion that is configured to be viewed when looking “behind them.” To do so in conventional techniques, the users typically turn their heads quickly due to the amount of display area of the content to be navigated between these viewpoints. However, this may cause a lag in detection of the movement and/or in rendering the content which may cause nausea because the motion of the users' heads does not track which portions of the digital content are being displayed to the users.

Accordingly, techniques and systems are described that incorporate a threshold to control how the digital content is viewed. A user, for instance, may specify an amount of movement via a user input in relation to a display of digital content, such as a 360-degree digital image, in an AR/VR scenario, and so forth. The amount of movement may be specified by a turn of the head, change in gaze, use of a virtual control above, and so forth. The amount of movement defines a transition from a first (i.e., initial) viewpoint to a second (i.e., target) viewpoint of the digital content.

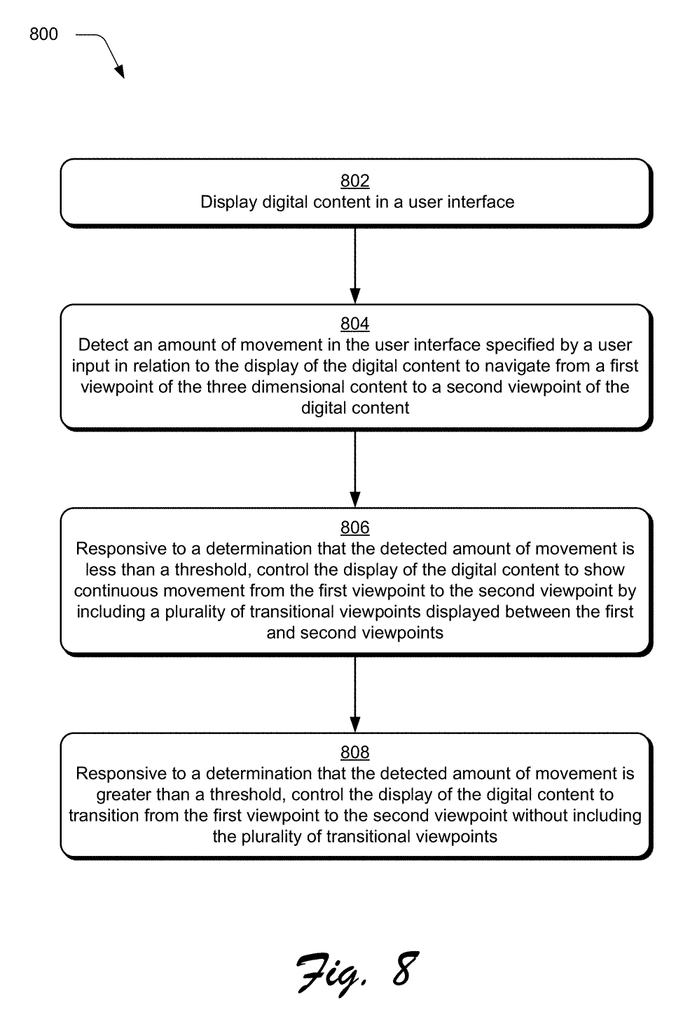

Based on this amount of movement, a determination is made through comparison to a threshold to control output of transitional viewpoints between the first and second viewpoints. For lesser amounts of movement that are below (or at) the threshold, for instance, the transitional viewpoints are output to provide a continuous view of the digital content. As such, the users remain immersed in viewing the digital content by panning through these transitional viewpoints in a manner that mimics “real life” immersion. For amounts over the threshold, however, output of at least one of the plurality of transitional viewpoints is not performed. In this way, a view of the user is “teleported” to the second viewpoint without being exposed to some or even all of these transitional viewpoints, thereby reducing a chance of user nausea that may be caused by rendering lag, errors in movement detection, and so forth. Further discussion of this example is described in relation to FIGS. 8-11 in the following sections.

In the following discussion, an example environment is first described that may employ the techniques described herein. Example procedures are also described which may be performed in the example environment as well as other environments. Consequently, performance of the example procedures is not limited to the example environment and the example environment is not limited to performance of the example procedures.

Example Environment

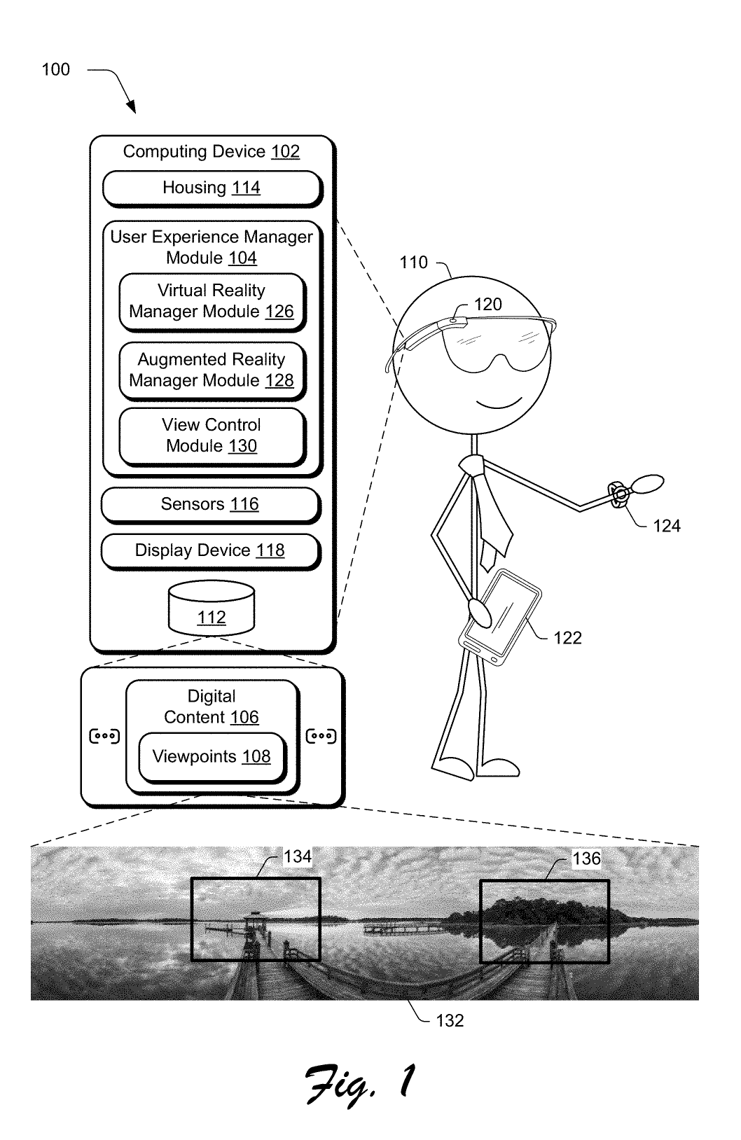

FIG. 1 is an illustration of an environment 100 in an example implementation that is operable to employ techniques described herein. The illustrated environment 100 includes a computing device 102 configured for use in augmented reality and/or virtual reality scenarios, which may be configured in a variety of ways.

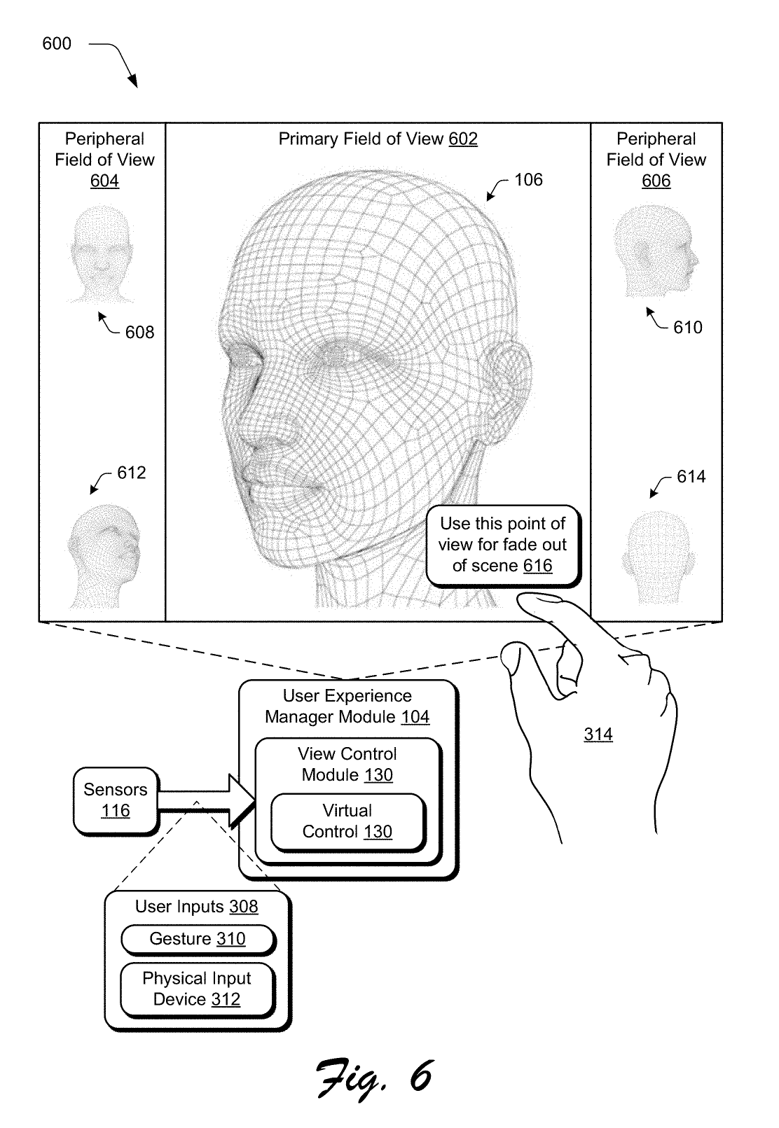

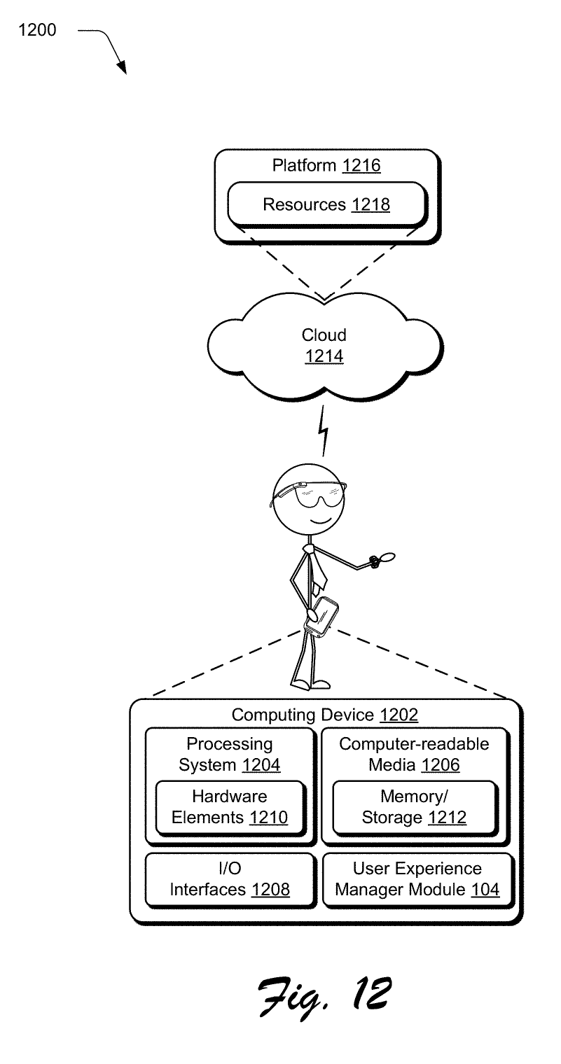

The computing device 102 is illustrated as including a user experience manager module 104 that is implemented at least partially in hardware of the computing device 102, e.g., a processing system and memory of the computing device as further described in relation to FIG. 12. The user experience manager module 104 is configured to manage output of and user interaction with digital content 106 having a plurality of viewpoints 108. Examples of such digital content 106 include immersive digital content such as 360-degree images, virtual objects displayed as part of a virtual or augmented reality scenario, and so forth that are made visible to a user 110. Other examples include use of three dimensional models, an example of which is shown in FIG. 6. The digital content 106 is illustrated as maintained in storage 112 of the computing device 102 but may be maintained elsewhere, such as “in the cloud” as also described in relation to FIG. 12.

The computing device 102 includes a housing 114, one or more sensors 116, and a display device 118. The housing 114 is configurable in a variety of ways to support interaction with the virtual user experience 106. In one example, the housing 114 is configured to be worn on the head of a user 110 (i.e., is “head mounted” 120), such as through configuration as goggles, glasses, contact lens, and so forth. In another example, the housing 114 assumes a hand-held 122 form factor, such as a mobile phone, tablet, portable gaming device, and so on. In yet another example, the housing 114 assumes a wearable 124 form factor that is configured to be worn by the user 110, such as a watch, broach, pendant, or ring. Other configurations are also contemplated, such as configurations in which the computing device 102 is disposed in a physical environment apart from the user 110, e.g., as a “smart mirror,” wall-mounted projector, television (e.g., a series of curved televisions arranged in a circular fashion), and so on.

The sensors 116 may also be configured in a variety of ways to detect a variety of different conditions. In one example, the sensors 116 are configured to detect an orientation of the computing device 102 in three dimensional space, such as through use of accelerometers, magnetometers, inertial devices, radar devices, and so forth. In another example, the sensors 116 are configured to detect environmental conditions of a physical environment in which the computing device 102 is disposed, such as objects, distances to the objects, motion, colors, and so forth. Examples of which include cameras, radar devices, light detection sensors (e.g., IR and UV sensors), time of flight cameras, structured light grid arrays, barometric pressure, altimeters, temperature gauges, compasses, geographic positioning systems (e.g., GPS), and so forth. In a further example, the sensors 116 are configured to detect environmental conditions involving the user 110, e.g., heart rate, temperature, movement, and other biometrics.

The display device 118 is also configurable in a variety of ways to support rendering of the digital content 106. Examples of which include a typical display device found on a mobile device such as a camera or tablet computer, a light field display for use on a head mounted display in which a user may see through portions of the display (e.g., as part of an augmented reality scenario), stereoscopic displays, projectors, and so forth. Other hardware components may also be included as part of the computing device 102, including devices configured to provide user feedback such as haptic responses, sounds, physical input devices, and so forth.

The housing 114, sensors 116, and display device 118 are also configurable to support different types of virtual user experiences by the user experience manager module 104. In one example, a virtual reality manager module 126 is employed to support virtual reality. In virtual reality, a user is exposed to an environment, the viewable portions of which are entirely generated by the computing device 102. In other words, everything that is seen by the user 110 is rendered and displayed by the display device 118 through use of the virtual reality manager module 126.

The user, for instance, may be exposed to virtual objects as part of the digital content 106 that are not “really there” (e.g., virtual bricks) and are displayed for viewing by the user in an environment that also is completely computer generated. The computer-generated environment may also include representations of physical objects included in a physical environment of the user 110, e.g., a virtual table that is rendered for viewing by the user 110 to mimic an actual physical table in the environment detected using the sensors 116. On this virtual table, the virtual reality manager module 126 may also dispose virtual objects 108 that are not physically located in the physical environment of the user 110, e.g., the virtual bricks as part of a virtual playset. In this way, although an entirely of the display being presented to the user 110 is computer generated, the virtual reality manager module 126 may represent physical objects as well virtual objects 108 within the display.

The user experience manager module 104 is also illustrated as supporting an augmented reality manager module 128. In augmented reality, the virtual objects of the digital content 106 are used to augment a direct view of a physical environment of the user 110. The augmented reality manger module 128, for instance, may detect landmarks of the physical table disposed in the physical environment of the computing device 102 through use of the sensors 116, e.g., object recognition. Based on these landmarks, the augmented reality manager module 128 configures the virtual bricks to appear as is placed on the physical table when viewed using the display device 118.

The user 110, for instance, may view the actual physical environment through head-mounted 120 goggles. The head-mounted 120 goggles do not recreate portions of the physical environment as virtual representations as in the VR scenario above, but rather permit the user 110 to directly view the physical environment without recreating the environment. The virtual objects 108 are then displayed by the display device 118 to appear as disposed within this physical environment. Thus, in augmented reality the digital content 106 acts to augment what is “actually seen” by the user 110 in the physical environment.

The user experience manager module 104 is also illustrated as including a view control module 130. The view control module 130 is configured to control navigation between viewpoints in digital content 106, such as viewpoints that are not viewable together (i.e., simultaneously) at any one time. An illustrated example of this is digital content configured as a 360-degree digital image 132. The 360-degree digital image 132 is configured to be viewed in an immersive environment such that the user may “turn” around to different viewpoints to view different portions of the content, such as a first viewpoint 134 and a second viewpoint 136. Due to field of view limitations (e.g., of the display device 118 and even the user 110), an entirety of the 360-degree digital image 132 is not viewable at any one time by the user 110.

Conventionally, to navigate such digital content the user 110 moved at least a portion of his head, e.g., the head as a whole, eyes, etc. In another example, a user held the computing device 102 when in a hand held 122 or wearable form factor and moved the device as a whole. This movement is detected using the sensors 116 and used to navigate to different portions of the 360-degree digital image 132, e.g., from the first viewpoint 134 of the dock to a second viewpoint 136 showing a portion of the dock that is “behind” the user 110.

As previously described, however, conventional navigation may quickly become tiring to the user 110. This is especially true in instances in which the user 110 is creating or modifying the digital content 106 by forcing the user to “move their head” to see and interact with different portions of the digital content 106 at different viewpoints. Accordingly, the view control module 130 is configured to support techniques to navigate through the digital content 106. In one example, a virtual control is configured to support manual interaction using one or more appendages (e.g., hands, fingers, etc.) of the user 110 to navigate between the first and second viewpoints 134, 136 without requiring the user 110 to move a portion of his head. This may be performed through interaction with a virtual control that is displayed by the displayed device 118 that mimics a dial or other physical tool, use of representations to “jump to” different viewpoints, and even use of a physical input device. Further discussion of use of the virtual control is described in relation to FIGS. 2-7 and corresponding section in the following.

In another example, the view control module 130 is configured to implement techniques to reduce potential of nausea as part of navigation through the digital content 106. This is performed through use of a threshold. When an amount of movement is detected that is under the threshold (e.g., a turn of the user's 110 head, use of the virtual control above, and so forth), the digital content 106 is rendered to include transitional viewpoints. In this way, the user 110 remains immersed as part of the digital content 106. However, when an amount of movement is detected that is over the threshold, the view control module 130 is configured to “teleport” or “jump” the user between the views by not outputting the transitional viewpoints. Further discussion of implementation of a threshold amount of movement is described in relation to FIGS. 8-11 and corresponding section in the following.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Digital Content Navigation Using a Virtual Control

FIGS. 2-7 depict example implementations of a virtual control that is usable to navigate digital content 106, such as immersive digital content, three-dimensional models, and so forth. The virtual control is configured to supplement navigation of the digital content 106 that may also be performed based on motion of a user's head or a computing device itself, e.g., by moving a mobile phone in three-dimensional space.

The following discussion describes techniques that may be implemented utilizing the described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference is made interchangeably to FIGS. 2-7.

FIG. 2 depicts a procedure 200 in an example implementation in which a virtual control is manipulated by an appendage of a user to control navigation of digital content that is also navigable based on at least partial motion of a user's head or a computing device used to display the content. To begin, three dimensional digital content is displayed in a user interface. The display of the three dimensional digital content is navigable via inputs involving at least partial motion of a user's head or a computing device (block 202). The digital content 106, for instance, may be displayed in three dimensions by a display device 118 of the computing device 102. Motion of the user's 110 head and/or the computing device 102 itself is detected using sensors to navigate between different viewpoints 108 of the digital content 106.

The user, for instance, may view an output of a first viewpoint 134 in a user interface displayed on a display device 118 incorporated as part of headwear 120 worn by the user 110. The user 110 then moves his head to the right, which is detected using the sensors 118, e.g., accelerometers, cameras, and so forth. In response, the use experience manager module 104 causes a panning motion to occur to move to display of the second viewpoint 136.

In another instance, the user 110 holds a hand-held 122 configuration of the computing device 102 to view the display device 118 such that it appears that the user 110 is looking through the display device 118 to view the digital content 106. Movement of the computing device 102 as a whole is detected using the sensors 116 and used to control navigation through the display of the digital content 106, such as from the first to second viewpoints 134, 136 as described above. Thus, in this instance the hand-held 122 configuration of the computing device 102 mimics a viewing portal into an environment of the digital content 106.

A user input is detected that is originated by at least one appendage of the user to specify manipulation of a virtual control in the user interface (block 204). In response to detection of the user input, navigation is controlled of the display of the three dimensional digital content in the user interface (block 206). The virtual control and corresponding user input may be implemented in a variety of ways, examples of which are discussed in the following.

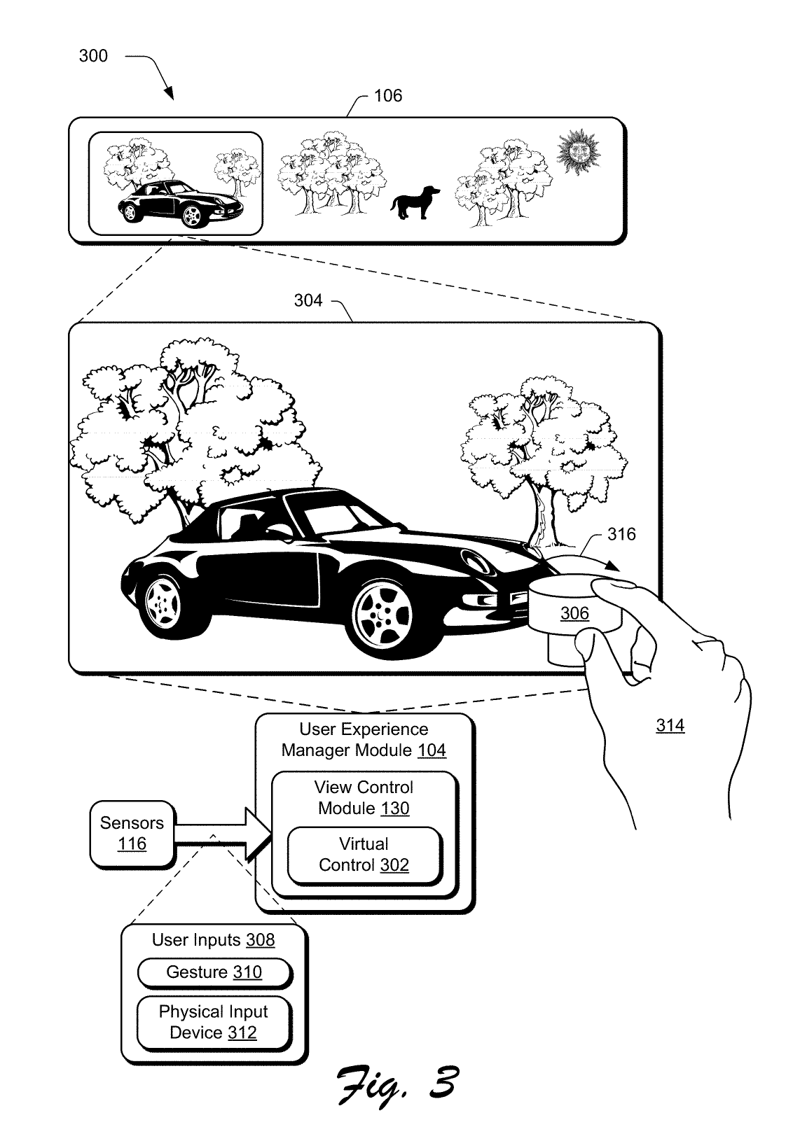

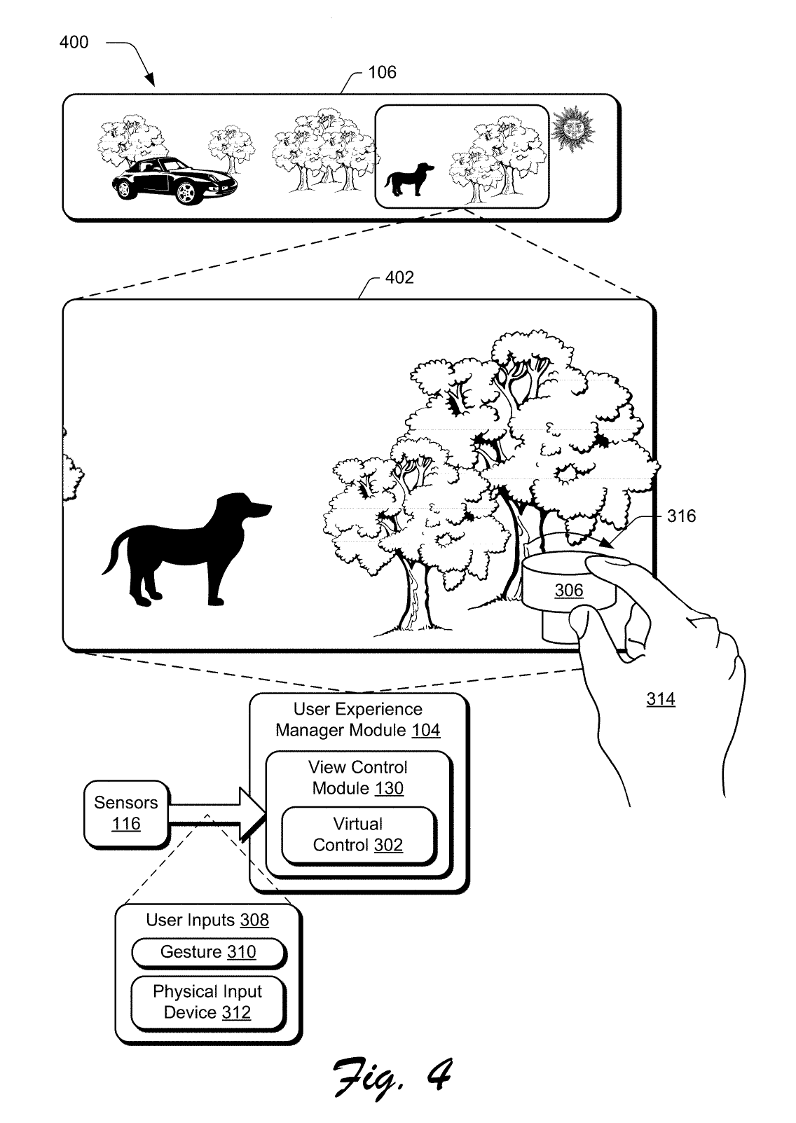

FIGS. 3 and 4 depict example implementations 300, 400 of the virtual control 302 of FIG. 2 as mimicking a physical control as part of a user interface that is used to display immersive digital content. The virtual control 302 is implemented by the view control module 130 of the user experience manager module 104. In this example, a first viewpoint 304 of digital content 106 is output by the user experience module 104 for viewing by a display device 118 of the computing device 102.

A representation 306 of the virtual control 302 is displayed concurrently with the first viewpoint 304 in this example. The representation 306 is configured to give a context for interaction and visual feedback regarding the interaction in this example. The sensors 116, for instance, may be configured to detect a variety of different user inputs 308, which may include a gesture 310 or interaction with a physical input device 312.

The sensors 116, for instance, may detect motion of a user's hand 314 in three dimensional space as a gesture 310 that does not involve contact with an actual physical device or surface of the computing device 102 as part of a natural user interface. In one example, the sensors 116 are configured to perform skeletal mapping based on images captured of the user's hand 314, arm as a whole, or even leg or foot. Other examples are also contemplated, such as to use radar techniques that employ radio waves, ultrasonic sensors, and so forth.

Regardless of how detected, the view control module 130 recognizes the gesture 310, an operation that corresponds to the gesture 310, and a degree to which the gesture 310 is to be performed. In the illustrated example, the representation 306 of the virtual control 302 mimics a physical dial. In this way, the representation 306 prompts the user as to a type of motion that is to be recognized as the gesture 310 and may also provide visual feedback as indicating to the user 110 that the gesture is recognized. For example, the representation 306 of the virtual control 302 as a dial indicates to the user 110 that rotational 316 movements of the user's hand 314 will be recognized as the gesture 310. Appearance of rotation of the representation 306 in the user interface displayed by the view control module 130 also provides feedback as to a likely degree to which the operation is to be performed as well as acknowledgement that the gesture 310 has been recognized by the computing device 102.

Similar techniques may be employed for use in conjunction with physical input devices 312. For example, the physical input device 312 may be configured as a physical dial that is manipulated manually by the user's hand 314. A representation 306 may also be provided in the user interface to also provide feedback as previously described, or may be implemented without the representation 306, e.g., is directly viewable in an AR scenario.

In response to the detection of the user inputs 308, the user interface output by the view control module 130 transitions from the first viewpoint 304 to a second viewpoint 402 as shown in FIG. 4. In this example, the second viewpoint 402 of the digital content 106 is not viewable concurrently with the first viewpoint 304. Thus, through use of the virtual control 302 the user 110 may control navigation of the digital content 106 in a user interface by also moving an appendage, which is less likely to induce user fatigue. The virtual control 302 may be implemented virtually in a variety of ways to mimic actual physical controls, such as sliders, buttons, and so forth. Likewise, the physical input device 312 may be implemented in a variety of ways, such as through use of dedicated hardware, keyboard (e.g., arrow keys), a mouse, a physical model of the digital content 106 that when moved in three dimensions causes corresponding movement of the display of the digital content 106, and so on. The virtual control 302 may be configured in a variety of other ways, examples of which are described in the following.

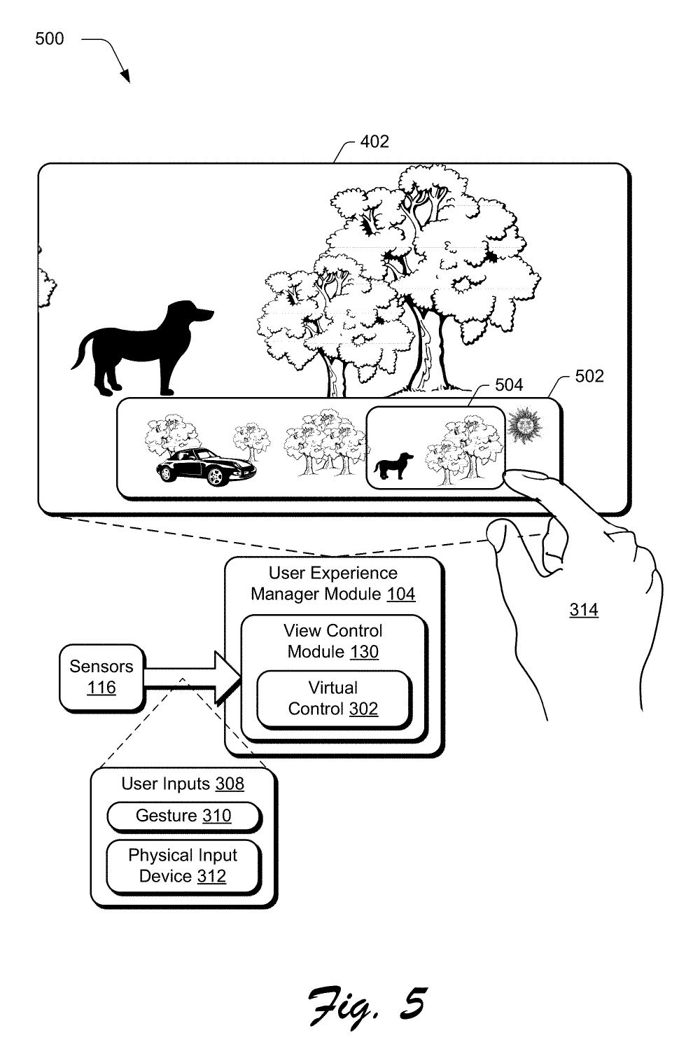

FIG. 5 depicts an example implementation 500 of the virtual control of FIG. 2 as implemented using representations of different viewpoints that are selectable to cause navigation to the represented viewpoints of immersive digital content. In this example, a reduced-view 502 of the digital content 106 is included in the user interface by the view control module 130 as a virtual control 302. Interaction with the reduced-view 502 is used to control navigation through the digital content 106, such as to move to different viewpoints through movement of an indication 504 of a current viewpoint. Other interactions are also supported, such as to change a scale through a pinch or expand gesture 310 by the user's hand 314 in relation to the indication 504 and/or the reduced view 502.

FIG. 6 depicts an example implementation 600 of the virtual control of FIG. 2 as implemented using representations of different viewpoints that are selectable to cause navigation to the represented viewpoints of digital content 106. The digital content 106 is this example is configured as a three-dimensional model. A user, for instance, may “walk around” the three-dimensional model through physical movement, e.g., in an augmented reality or virtual reality scenario. A user may also “grab and move” different portions of the digital content 106 in space to change views.

The virtual control 130 in this example also includes a plurality of representations of different viewpoints of the three dimensional digital content 106 that are user selectable to cause navigation to respective viewpoints in the user interface. Further, these representations are positioned within the user interface to take advantage of different fields of view of a user 110. As illustrated, for instance, the user interface includes a primary fields of view 602 and peripheral fields of view 604, 606. The digital content 106 is displayed in the primary field of view 602. Representations 608, 610, 612, 614 are also displayed in the user interface in the peripheral fields of view 604, 606. The representations 608-614 are selectable to cause navigation to the represented viewpoint in the primary field of view 602. In an immersive digital content example, the representations may be configured as “virtual mirrors” positioned and fixed in relation to a current viewpoint of the user such that selection of the different viewpoints and relation to a current viewpoint is readily understood by the user 110.

Functionality may also be associated with particular viewpoints. An example of this is an annotation 616 that is made visible when viewing the digital content 106 at the illustrated viewpoint but is not made visible at other viewpoints. In this way, a user may specify additional content to be viewed in a manner that reduces clutter in the user interface.

Additional functionality may also be incorporated to increase a likelihood that a user views the digital content 106 from a particular viewpoint. When a plurality of users creates immersive digital content 106, for instance, a sound may be output by the computing device 102 in relation to the user 110 that corresponds to a viewpoint at which another user is interacting with the content. A user may then quickly navigate to that location in an intuitive manner other examples of notifications using sound as corresponding to particular viewpoints are also contemplated, such as to prompt a user to interact with a particular virtual object in an AR/VR scenario.

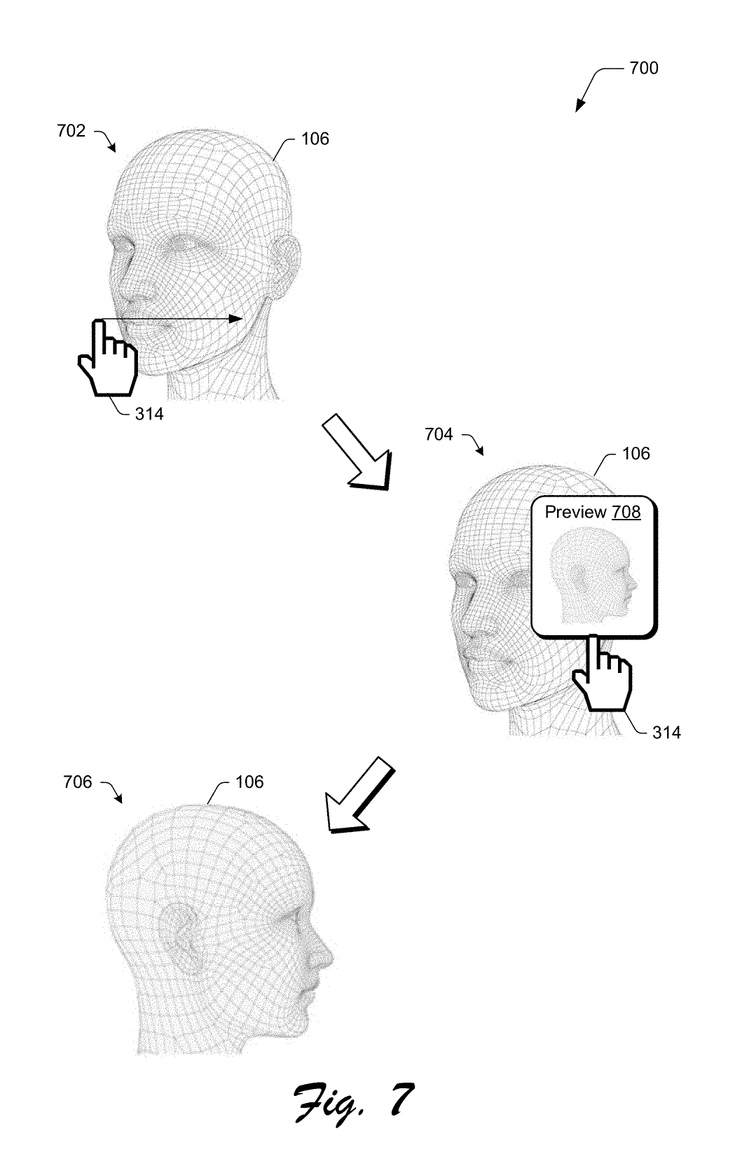

FIG. 7 depicts an example implementation 700 of navigation between viewpoints that includes output of a preview. This example implementation is illustrated using first, second, and third stages 702, 704, 706. At the first stage 702, a gesture is recognized by the view control module 130. The gesture in this example is performed by a user's hand 314 and describes navigation of digital content (e.g., a three dimensional model or immersive digital content) from a first viewpoint to a second viewpoint. The gesture 314 in this instance describes a direction of navigation and a magnitude that together are usable by the view control module 130 to determine a target viewpoint.

This determination of the target viewpoint is then used to generate a preview 708 as shown at the second stage 704. The preview 708 of the target viewpoint includes a representation of the second viewpoint that is displayed concurrently with the first viewpoint of the first stage 702. In this way, the preview 708 describes “where the navigation is to end up” as part of the gesture. Output of the preview 708 may be performed in real time such that a user may refine the target viewpoint through continued movement that maintains performance of the gesture.

Once the input of the gesture has ceased (e.g., performance of the gesture is stopped by the user 110), the view control module 140 replaces the first viewpoint of the digital content 106 with the target viewpoint 106 from the previous 708 and removes the preview 708. The user, for instance, may “lift the finger” of the user's hand away to cause the gesture to be recognized as completed by the view control module 130. In this way, resources of the computing device 102 may be conserved and yet promote accurate navigation as specified by a user that may be refined before causing a switch in viewpoints.

Digital Content Navigation that Addresses Potential Nausea

FIGS. 8-11 depict example implementations to control navigation of digital content 106, such as immersive digital content, three-dimensional models, and so forth, in a manner that is likely to reduce and even eliminate nausea caused by conventional navigation techniques.

The following discussion describes techniques that may be implemented utilizing the described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference is made interchangeably to FIGS. 8-11.

FIG. 8 depicts a procedure 800 in an example implementation in which navigation in relation to digital control is controlled through use of a threshold. To begin, digital content 106 is displayed in a user interface (block 802). This may include immersive digital content, three-dimensional models, and so forth displayed by the display device 118 of the computing device. The digital content 106 includes a plurality of viewpoints 108 as previously described, which may or may not be viewable together at any one time.

An amount of movement is detected in the user interface as specified by a user input in relation to the display of the digital content. The amount of movement is to navigate from a first viewpoint of the three dimensional content to a second viewpoint of the digital content (block 804). The amount of movement that is detected is used to control now navigation within the digital content 106 is to be displayed to a user.

For example, sensors may detect that a user input has been received to navigate from a first viewpoint 902 to a second viewpoint 904 in digital content 106. The view control module 130 may then determine an amount of movement 906 involved in this navigation, which is compared to a threshold 908. In this example, the detected amount of movement 906 is determined to be less than the threshold 908. In response, the view control module enters a panning mode 910 in which the display of the digital content is controlled to show continuous movement from the first viewpoint to the second viewpoint by including a plurality of transitional viewpoints displayed between the first and second viewpoints (block 806).

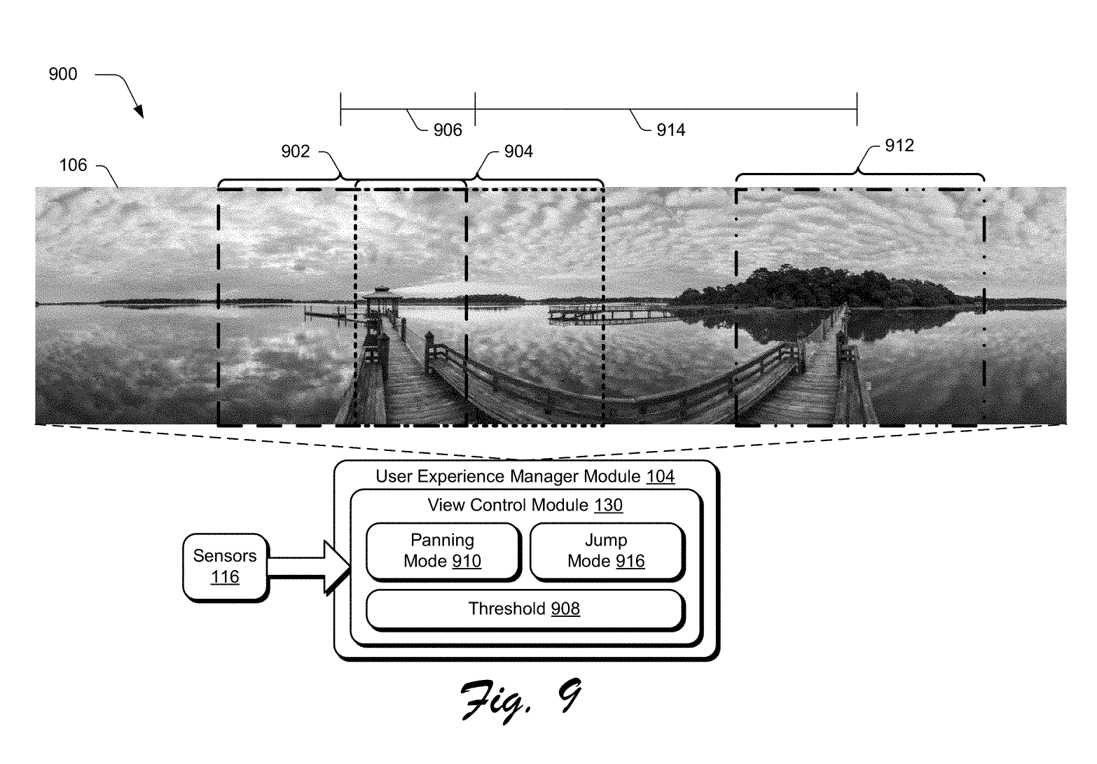

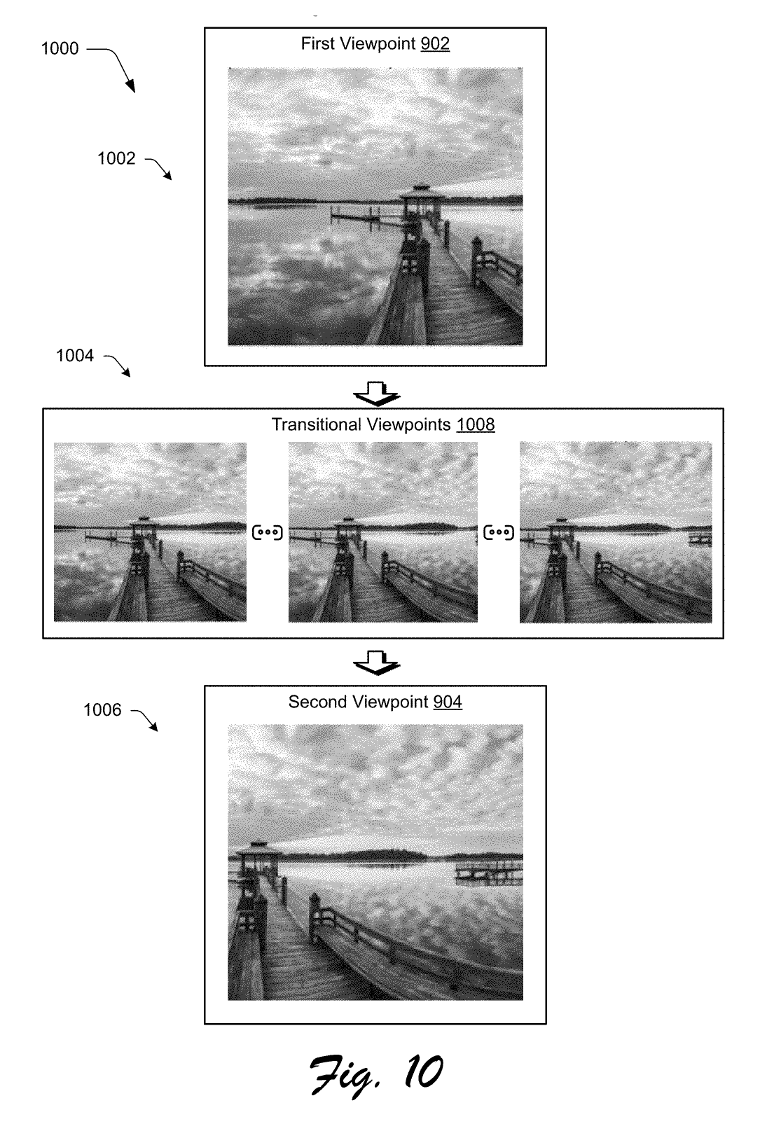

FIG. 10 depicts an example implementation 1000 of control of display of the digital content as including transition viewpoints to support an appearance of continuous movement in relation to the digital content 106. This implementation is illustrated using first, second, and third stages 1002, 1004, 1006. At the first stage 1002, the first viewpoint 902 is displayed for viewing by the user. The amount of movement 906 detected as described in relation to FIG. 9 specifies movement to a second viewpoint 904 as shown at the third stage 1006.

The amount of movement in this example between the first and second viewpoints 902, 904 is less than a threshold 908. The threshold 908 may be defined in a variety of ways, such as through testing to determine an amount of movement that does not cause nausea, e.g., due to software or hardware limitations of the computing device 102 and/or the digital content 106 itself. The threshold 906 may also define a distance in relation to the digital content, e.g., whether the viewpoints include overlapping digital content, and so forth.

Because the amount of movement is less than the threshold in this example, a plurality of transitional viewpoints 1008 are output at the second stage 1004 between the output of the first and second viewpoints 902, 904 at the first and third stages 1002, 1006. For example, the output of the first viewpoint 902 at the first stage 1002 is followed by the plurality of transitional viewpoints 1008 at the second stage 1004 and ends at the output of the second viewpoint 904 at the third stage 1006. This may be configured to provide an appearance of continuous (i.e., panning) motion in relation to the digital content 106 and thus supports continued immersion of the user in viewing the digital content 106 without exposing the user to potential nausea.

Returning back to FIG. 9, sensors 116 may detect that a user input has been received to navigate from a first viewpoint 902 to a different second (i.e., target) viewpoint 912 in the digital content 106. The view control module 130 then determines an amount of movement 914 involved in this navigation, which is compared to a threshold 908. In this example, the detected amount of movement 914 is determined to be greater than the threshold 908. In response, the view control module 130 enters a “jump” (i.e., teleportation) mode 916 in which the display of the digital content is controlled to transition (e.g., jump) from the first viewpoint 902 to the second viewpoint 912 without including a plurality of transitional viewpoints displayed between the first and second viewpoints (block 808).

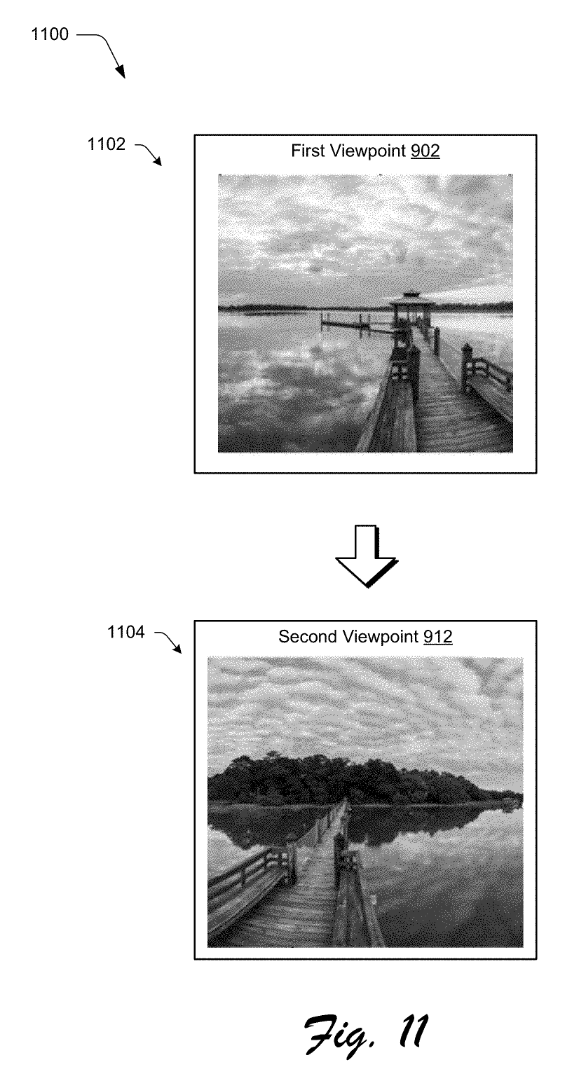

FIG. 11 depicts an example implementation 1100 of control of display of the digital content 106 as not including transitional viewpoints to support an appearance of jumping between different viewpoints in the digital content. This example implementation 1100 is illustrated using first and second stages 1102, 1004. Continuing with the previous discussion of FIG. 9, the user input specified movement from the first viewpoint 902 in the digital content 106 to the second viewpoint 912 in the digital content 106.

In this example, this amount of movement involves approximately 180 degrees, e.g., looking down a dock in the first viewpoint 902 and back behind the dock in the second viewpoint 912. Accordingly, rendering of each of the plurality of transitional viewpoints as done previously for the example of FIG. 10 may cause nausea if rendered due to this amount of movement. Therefore, rendering of at least some of these transitional viewpoints is skipped in this example to jump from display of the first viewpoint 902 to display of the second viewpoint 912. In one example, some other digital content may be displayed during this movement. For instance, an amount of movement may be detected when crossing the threshold 908. At that point, rendering of transition viewpoints may stop until this movement ceases, at which point the second viewpoint 912 is displayed that corresponds to “where the user ended up.” Other content may also be rendered (e.g., a “gray screen”), rendering may cease entirely, and so forth instead of the rendering of the transitional viewpoints of the digital content 106. In this way, a likelihood of a user 110 experiencing nausea when interacting with the digital content 106 may be reduced and even eliminated.

Example System and Device

FIG. 12 illustrates an example system generally at 1200 that includes an example computing device 1202 that is representative of one or more computing systems and/or devices that may implement the various techniques described herein. This is illustrated through inclusion of the user experience manager module 104. The computing device 1202 may be, for example, a server of a service provider, a device associated with a client (e.g., a client device), an on-chip system, and/or any other suitable computing device or computing system.

The example computing device 1202 as illustrated includes a processing system 1204, one or more computer-readable media 1206, and one or more I/O interface 1208 that are communicatively coupled, one to another. Although not shown, the computing device 1202 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1204 is representative of functionality to perform one or more operations using hardware. Accordingly, the processing system 1204 is illustrated as including hardware element 1210 that may be configured as processors, functional blocks, and so forth. This may include implementation in hardware as an application specific integrated circuit or other logic device formed using one or more semiconductors. The hardware elements 1210 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1206 is illustrated as including memory/storage 1212. The memory/storage 1212 represents memory/storage capacity associated with one or more computer-readable media. The memory/storage component 1212 may include volatile media (such as random access memory (RAM)) and/or nonvolatile media (such as read only memory (ROM), Flash memory, optical disks, magnetic disks, and so forth). The memory/storage component 1212 may include fixed media (e.g., RAM, ROM, a fixed hard drive, and so on) as well as removable media (e.g., Flash memory, a removable hard drive, an optical disc, and so forth). The computer-readable media 1206 may be configured in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1202. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1202, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1210. The computing device 1202 may be configured to implement particular instructions and/or functions corresponding to the software and/or hardware modules. Accordingly, implementation of a module that is executable by the computing device 1202 as software may be achieved at least partially in hardware, e.g., through use of computer-readable storage media and/or hardware elements 1210 of the processing system 1204. The instructions and/or functions may be executable/operable by one or more articles of manufacture (for example, one or more computing devices 1202 and/or processing systems 1204) to implement techniques, modules, and examples described herein.

The techniques described herein may be supported by various configurations of the computing device 1202 and are not limited to the specific examples of the techniques described herein. This functionality may also be implemented all or in part through use of a distributed system, such as over a “cloud” 1214 via a platform 1216 as described below.

The cloud 1214 includes and/or is representative of a platform 1216 for resources 1218. The platform 1216 abstracts underlying functionality of hardware (e.g., servers) and software resources of the cloud 1214. The resources 1218 may include applications and/or data that can be utilized while computer processing is executed on servers that are remote from the computing device 1202. Resources 1218 can also include services provided over the Internet and/or through a subscriber network, such as a cellular or Wi-Fi network.

The platform 1216 may abstract resources and functions to connect the computing device 1202 with other computing devices. The platform 1216 may also serve to abstract scaling of resources to provide a corresponding level of scale to encountered demand for the resources 1218 that are implemented via the platform 1216. Accordingly, in an interconnected device embodiment, implementation of functionality described herein may be distributed throughout the system 1200. For example, the functionality may be implemented in part on the computing device 1202 as well as via the platform 1216 that abstracts the functionality of the cloud 1214.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to control navigation of three dimensional digital content, a method implemented by a computing device, the method comprising:
displaying, by the computing device, three dimensional digital content in a user interface, the display of the three dimensional digital content navigable via inputs involving at least partial motion of a user's head or the computing device;
detecting, by the computing device, a user input originated by at least one appendage of the user to specify manipulation of a virtual control in the user interface; and
controlling navigation, by the computing device, of the display of the three dimensional digital content in the user interface in response to the detecting of the user input.

2. The method as described in claim 1, wherein the displaying of the three dimensional digital content is immersive to appear via a plurality of viewpoints in the user interface as at least partially surrounding a user.

3. The method as described in claim 2, wherein the controlling of the navigation includes transitioning from displaying the three dimensional digital content at a first said viewpoint in the user interface to displaying the three dimensional digital content at a second said viewpoint in the user interface.

4. The method as described in claim 1, wherein the detecting includes recognizing a gesture performed by the at least one appendage of the user in relation to a display of the virtual control in the user interface.

5. The method as described in claim 4, wherein the controlling of the navigation includes displaying feedback that appears as motion of the virtual control in the user interface that corresponds to the manipulation of the virtual control in real time as part of the recognized gesture.

6. The method as described in claim 1, wherein the detecting is performed using at least one camera of the at least one computing device as part of a natural user interface.

7. The method as described in claim 1, wherein the detecting includes receiving at least one input from a physical input device manipulated manually by the at least one appendage of the user.

8. The method as described in claim 1, wherein the virtual control includes a plurality of representations of different viewpoints of the three dimensional digital content that are user selectable to cause navigation to respective said viewpoints in the user interface.

9. The method as described in claim 1, wherein the virtual control is displayed in the user interface to mimic a physical control that is moveable by the at least one appendage of the user.

10. The method as described in claim 1, wherein the controlling of the navigation includes:
responsive to a determination that a detected amount of movement specified by the manipulation of the virtual control is less than a threshold, controlling the displaying of the three dimensional digital content to show continuous movement from a first viewpoint to a second viewpoint of the user interface by including a plurality of transitional viewpoints displayed between the first and second viewpoints; and
responsive to a determination that the detected amount of movement specified by the manipulation of the virtual control is greater than a threshold, controlling the displaying of the three dimensional digital content to transition from the first viewpoint to the second viewpoint without including the plurality of transitional viewpoints.

11. In a digital medium environment to control navigation of three dimensional digital content, a method implemented by at least one computing device, the method comprising:
displaying, by the at least one computing device, digital content in a user interface;
detecting, by the at least one computing device, an amount of movement in the user interface specified by a user input in relation to the display of the digital content to navigate from a first viewpoint of the three dimensional content to a second viewpoint of the digital content;
responsive to a determination that the detected amount of movement is less than a threshold, controlling the displaying of the digital content to show continuous movement from the first viewpoint to the second viewpoint by including a plurality of transitional viewpoints displayed between the first and second viewpoints; and
responsive to a determination that the detected amount of movement is greater than a threshold, controlling the displaying of the digital content to transition from the first viewpoint to the second viewpoint without including the plurality of transitional viewpoints.

12. The method as described in claim 11, wherein the threshold is defined such that an amount of movement below the threshold includes overlap of the first and second viewpoints and an amount of movement above the threshold does not include overlap of the first and second viewpoints.

13. The method as described in claim 11, wherein the detecting of the amount of movement includes recognizing a gesture corresponding to the amount of movement as ending at a location in the user interface and further comprising:
displaying a preview of the second viewpoint of the digital content in the user interface simultaneously with at least a portion of the three dimensional content as viewed at the first viewpoint; and
responsive to determining that input of the gesture has ceased at the location in the user interface, replacing the display of the first viewpoint of the digital content with a display of the second viewpoint of the digital content and removing the preview from the user interface.

14. The method as described in claim 13, wherein the displaying of the preview is performed in real time as inputs specifying the amount of movement are received by the at least one computing device.

15. In a digital medium environment to control navigation of three dimensional digital content, a computing device comprising:
a display device;
at least one sensor; and
a view control module implemented using a processing system and computer-readable storage media, the view control module configured to:
display three dimensional digital content in a user interface on the display device, the display of the three dimensional digital content navigable via inputs involving at least partial motion of a user's head detected using the at least one sensor;
detect a user input by the at least one sensor, the detected user input originated by at least one appendage of the user to specify manipulation of a virtual control in the user interface; and
control navigation of the display of the three dimensional digital content in the user interface in response to the detected user input.

16. The computing device as described in claim 15, wherein the display of the three dimensional digital content is immersive to appear via a plurality of viewpoints in the user interface as at least partially surrounding a user.

17. The computing device as described in claim 16, wherein the control of the navigation includes transitioning from a display of the three dimensional digital content at a first said viewpoint in the user interface to displaying the three dimensional digital content at a second said viewpoint in the user interface.

18. The computing device as described in claim 15, wherein the detection of the user input includes recognizing a gesture performed by the at least one appendage of the user in relation to a display of the virtual control in the user interface.

19. The computing device as described in claim 15, wherein the detection of the user input includes receiving at least one input from a physical input device manipulated manually by the at least one appendage of the user.

20. The computing device as described in 15, wherein the virtual control includes a plurality of representations of different viewpoints of the three dimensional digital content that are user selectable to cause navigation to respective said viewpoints in the user interface.
